(19) United States
(12) Patent Application Publication
(10) Pub. No.: US 2009/0186727 A1
(43) Pub. Date: Jul. 23, 2009

(54) Tensioner

(76) Inventors: Alexander Serkh, Troy, MI (US); Peter Ward, Farmington Hills, MI (US)

Correspondence Address: THE GATES CORPORATION, IP LAW DEPT. 10-A3, 1551 WEWATTA STREET, DENVER, CO, 80202, US

(21) Appl. No.: 12/009,509

(22) Filed: Jan. 18, 2008

(51) Int. Cl. F16H 7/10

(52) U.S. Cl. 474/112

(57) ABSTRACT

A tensioner comprising a base, a pivot arm pivotally engaged with the base, a pulley journalled to the pivot arm, the pulley mounted to the inner race of a bearing, the outer race mounted to the pivot arm, a spring engaged between the pivot arm and a damping mechanism, the damping mechanism frictionally engaged with the pivot arm, the damping mechanism slidingly engaged with the base between at least two predetermined mechanically fixable positions, and the pivot arm, spring and damping mechanism contained within a pulley perimeter.

### FIELD OF THE INVENTION

The invention relates to a tensioner, and more particularly, having the damping mechanism slidingly engaged with the base between at least two predetermined mechanically fixable positions.

### BACKGROUND OF THE INVENTION

Eccentric tensioners are used to apply a load to power transmission belts, which includes synchronous belts or toothed belts. For example, toothed belts are used on engine cam drives for power transmission and timing purposes.

A tensioner is used to apply a proper belt load which in turn assures proper operation of the belt drive system of which the tensioner and belt are a part.

Such tensioners generally comprise a torsion spring and an eccentric pivot arm which creates a lever arm to apply a spring load to the belt.

During the operating life of an engine a toothed belt will slightly change length due to wear and other factors. This condition must be accommodated by the tensioner.

In addition, during load reversals, for example during engine deceleration, the tensioner must be able to prevent the belt from becoming unduly slack which can lead to a condition called “ratcheting” where the belt can “jump” across the teeth of sprockets in the system. This can lead to catastrophic changes in the engine timing and premature failure of the belt.

Ratchet and pawl systems are used to prevent tensioner pivot arms from excessive recoil during load reversals. Once released the ratchet and pawl systems cannot be relocked.

Representative of the art is U.S. Pat. No. 7,217,207 to Hallen which discloses a tensioner comprising a base having a toothed portion, a pivot arm pivotally engaged with the base, a pulley journalled to the pivot arm, a spring disposed between the base and the pivot arm for biasing the pivot arm in a first direction, a mechanism disposed on the pivot arm and engaged with the base, the mechanism comprising a rotatable geared member and a second spring engaged between the geared member and the pivot arm, the second spring biasing the pivot arm in the first direction, and the geared member having a non-toothed portion that when the non-toothed portion is engaged with the toothed portion it prevents substantial rotation of the pivot arm in a reverse direction from the first direction.

What is needed is a tensioner having the damping mechanism slidingly engaged with the base between at least two predetermined mechanically fixable positions. The present invention meets this need.

### SUMMARY OF THE INVENTION

The primary aspect of the invention is to provide a tensioner having the damping mechanism slidingly engaged with the base between at least two predetermined mechanically fixable positions.

Other aspects of the invention will be pointed out or made obvious by the following description of the invention and the accompanying drawings.

The invention comprises a tensioner comprising a base, a pivot arm pivotally engaged with the base, a pulley journalled to the pivot arm, the pulley mounted to the inner race of a bearing, the outer race mounted to the pivot arm, a spring engaged between the pivot arm and a damping mechanism, the damping mechanism frictionally engaged with the pivot arm, the damping mechanism slidingly engaged with the base between at least two predetermined mechanically fixable positions, and the pivot arm, spring and damping mechanism contained within a pulley perimeter.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is an exploded view.

FIG. 2 is a partial detail of the spring connection to the arm.

FIG. 3 is a detail of the spring connection to the damping mechanism.

FIG. 4 is a cutaway view of the tensioner in the unloaded position.

FIG. 5 is a cutaway view of the tensioner in a first load position.

FIG. 6 is a cutaway view of the tensioner in a second load position.

FIG. 7 is a cutaway view of the tensioner in a third load position.

FIG. 8 is a cutaway view of the tensioner in a fourth load position.

FIG. 9 is a top perspective view of the tensioner.

FIG. 10 is a bottom perspective view of the tensioner.

FIG. 11 is a cross-sectional view of the tensioner.

FIG. 12 is a perspective cross-sectional view of the tensioner.

FIG. 13 is a chart showing belt tension as a function of arm position.

### DETAILED DESCRIPTION OF THE PREFERRED EMBODIMENT

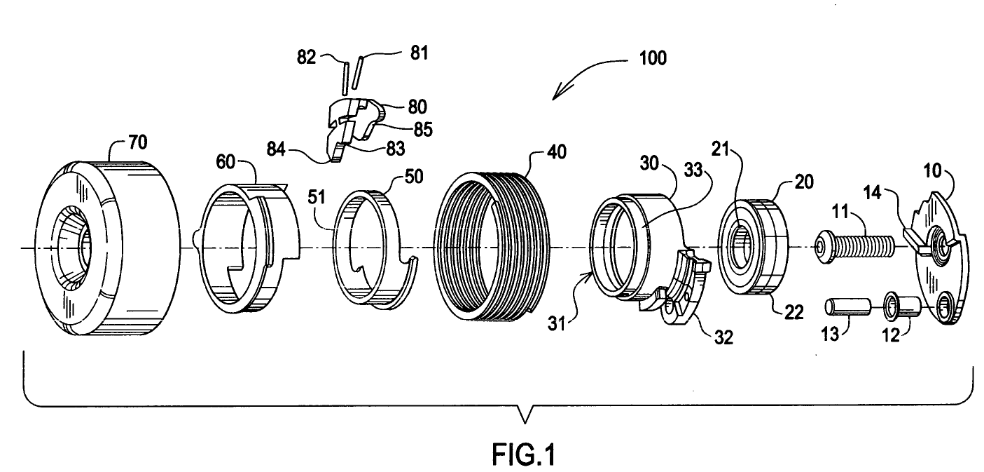

FIG. 1 is an exploded view. The tensioner comprises a base 10. Base 10 is connectable by a fastener 11 to a mounting surface (not shown), for example, a vehicle engine. Pivot pin 13 and sleeve 12 are also engaged with base 10. Arm 30 is pivotally connected to pivot pin 13 through member 32. Arm 30 may comprise metallic materials, such as aluminum or steel, or plastic materials or their equivalents.

Bearing 20 is mounted within arm 30 in bore 31. Bearing 20 is preferably a ball bearing, but may also comprise a needle bearing or other equivalent bearing known in the art.

Pulley 70 is the component that directly contacts the belt to provide tension. Pulley 70 is engaged with bearing 20. Pulley 70 is attached directly to the bearing inner race 21 as opposed to the outer race 22, which is the typical method used for tensioners. This configuration makes the outer race 22 the static member since it is the outer race which is mounted to arm 30. The outer race as opposed to the inner race being static is advantageous because it reduces the stress on the balls inside the bearing, thereby enhancing operating life of the bearing.

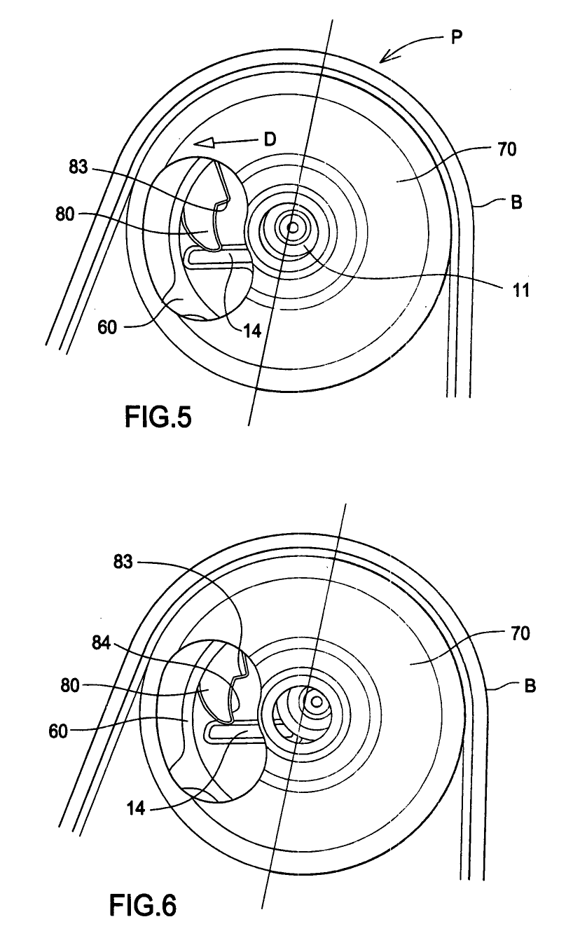

Spring 40 is connected to the damping mechanism 60 and to the arm 30. Spring 40 is a helical torsion spring. The spring torque when applied to arm 30 and to damping mechanism 60 is used to create two component forces that contribute to belt tension. Arm 30 pivots about the pivot pin 13 when spring torque is applied to the damping mechanism 60. Damping cam 80 is fixedly connected to the damping mechanism 60 with pins 81, 82, or by any other equivalent means of attachment. Damping cam 80 reacts against the base 10 thereby forcing the arm 30 to pivot about the pivot pin 13. Damping cam 80 slides along the contact surface (member 14) on the base 10, which increases the distance between the hub load plane and the contact point on the cam surface to decrease the force generated by the damping mechanism as the tensioner moves from the free arm (unloaded) to the load condition, see FIG. 4.

Damping of arm oscillations during operation is created by the following three components: damping band 50, pivot bushing 12, and damping cam 80. “Damping” is the reduction or elimination of oscillations of pivot arm 30 caused by movement of belt B. The three components (50, 12, 80) generate damping through one of two means. The first being friction about the axis of rotation (pivot 13) and the second by thrust for balancing. Damping band 50 creates damping through both means.

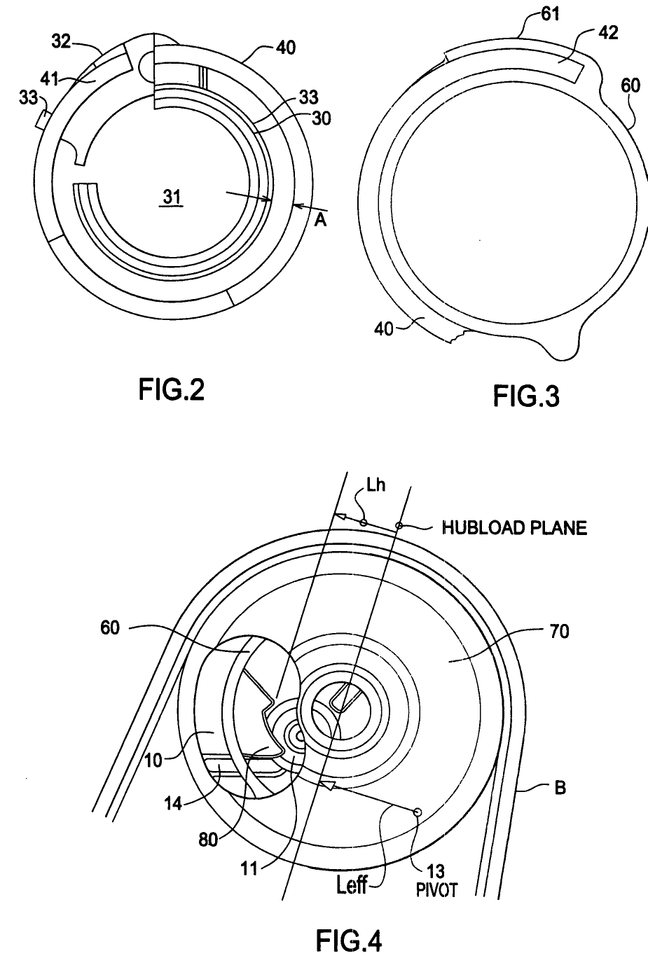

FIG. 2 is a partial detail of the spring connection to the arm. End 41 of spring 40 is fixedly connected to member 32 of arm 30. Tab 33 retains end 41 in member 32. The damping mechanism 60 and damping band 50 (omitted in this figure for clarity) are disposed between spring 40 and arm 30 in space “A”.

An inner surface 51 of damping band 50 frictionally bears upon outer surface 33 of arm 30. Damping band 50 and surface 33 have a coefficient of friction in the range of approximately 0.1 to 0.5. Damping band 50 may comprise plastic, ceramic or metallic materials and their equivalents, or a combination of two or more of the foregoing.

FIG. 3 is a detail of the spring connection to the damping mechanism. End 42 of the spring 40 is fixedly connected to the member 61 of damping mechanism 60. Member 61 comprises a slot 62 within which end 42 is fixedly disposed.

FIG. 4 is a cutaway view of the tensioner in the unloaded position. Belt B is engaged with pulley 70. Damping cam 80 is slidingly engaged with base member 14. Damping cam 80 slidingly engages base member 14 thereby allowing damping cam 80 to slide along the surface of base member 14 as arm 30 and damping mechanism 60 pivot. Member 14 is substantially linear. Damping band 50, spring 40 and arm 30 are omitted from FIGS. 4-8 for clarity.

The damping band 50 generates damping about the axis of rotation of the damping mechanism, but the geometry also lends itself to creating a separate feature to help balance thrust. The pivot bushing 12 creates damping by friction along the axis of rotation of the arm on the pivot bushing and the damping cam creates damping purely through thrust for balancing.

Belt tension is created by using spring 40 to generate force from the arm 30 and from the damping mechanism 60. The force generated by the arm 30 is simply a function of the spring torque and the effective arm length (see equation 1). The force from the damping mechanism 60 is a function of the spring torque and the distance between the hub load plane and the point of contact at the cam surfaces (see equation 2). See FIG. 4 for drawing references.

Fₐᵣₘ=T/L_{eff} Equation 1

Fₐᵣₘ: Force generated by arm

T: Spring Torque

L_{eff}: Effective Arm Length (distance from center of pivot 12 to center of pulley 70)

F_{damp}=T/Lₕ Equation 2

F_{damp}: Force generated by damping mechanism

T: Spring Torque

Lₕ: Distance between the hubload plane (through center of rotation of pulley 70) and point of contact between the cam lobes and the member 14.

An example set of calculations give the following results for each operating condition in FIGS. 4, 5, 6, 7, 8:

| | Spring | Damping | Arm | Total | Belt |
|---|---|---|---|---|---|
| FIG. | Torque | Force | Force | Force | Tension |
| 4 | 4.3 Nm | 322.0 N | 272.3 N | 594.3 N | 297.2 N |
| 5 | 5.9 Nm | 367.1 N | 265.7 N | 632.9 N | 316.4 N |
| 6 | 6.4 Nm | 388.0 N | 272.5 N | 660.0 N | 330.0 N |
| 7 | 6.9 Nm | 407.0 N | 281.5 N | 688.5 N | 344.4 N |
| 8 | 7.8 Nm | 501.9 N | 298.3 N | 800.2 N | 400.1 N |

The belt tension (load) is optimized to be near constant from free arm (FIG. 4) to minimum belt position through the means of cam lobes 83, 84 engaging base plate member 14 (FIG. 6). The damping cam 80 allows the tensioner to easily pivot while controlling the amount of spring angular displacement to optimize the belt tension. The damping cam 80 also permits the spring force to be minimized after the minimum belt position, see FIG. 8. Minimizing the load past the minimum belt position prevents the spring from being overloaded and makes it easier to install a belt B.

FIG. 5 is a cutaway view of the tensioner in a first load position. Compared to FIG. 4, one can see that damping cam 80 has moved in direction “D” along the surface of member 14. Arm 30 has also pivoted in direction P by pivoting about pivot 13 (FIG. 4). This FIG. 5 represents a greater belt load than is shown in FIG. 4.

Movement of damping cam 80 occurs because as arm 30 moves in direction P, the damping mechanism 60 partially rotates about arm 30 in the opposite direction to the pivot direction. As damping mechanism 60 rotates, the damping cam is moved radially outward along member 14.

FIG. 6 is a cutaway view of the tensioner in a second load position. Damping cam 80 comprises lobe 83 and lobe 84. During low load operation lobe 84 engages member 14. FIG. 6 shows the tensioner having a belt load greater than the load depicted in FIG. 5. Arm 30 has pivoted further in direction P.

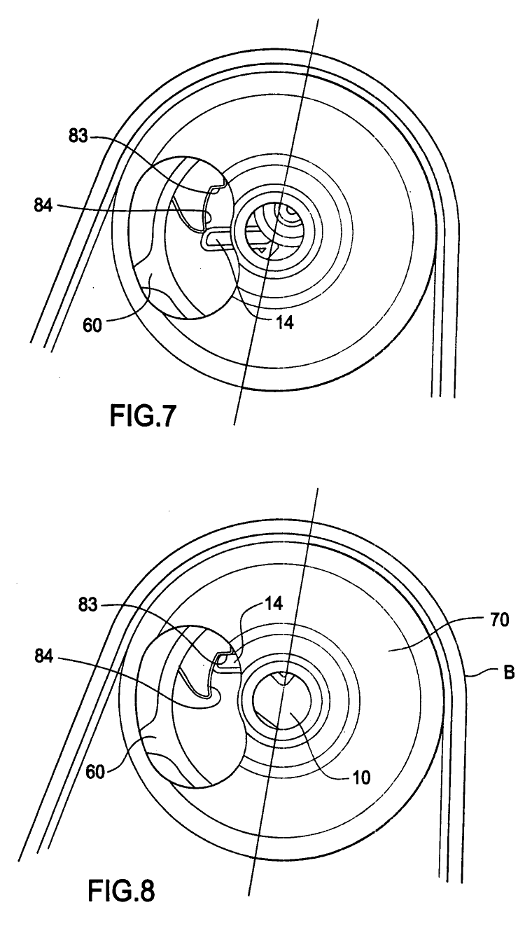

FIG. 7 is a cutaway view of the tensioner in a third load position. Lobe 84 has moved further radially outward to an end of member 14. FIG. 7 shows the tensioner having a belt load greater than the load depicted in FIG. 6. FIGS. 4 to 7 represent a sequence of increasing belt load and increasing pivotal movement of arm 30 about pivot 13.

FIG. 8 is a cutaway view of the tensioner in a fourth load position. In this figure the arm 30 has pivoted yet farther in direction P. Damping cam 80 has moved radially outward further along member 14 than shown in FIG. 7. In doing so damping cam 80 has changed engagement with member 14 from lobe 84 to lobe 83, thereby mechanically fixing the position of the damping mechanism in a predetermined position with respect to the base.

The geometry of damping cam 80, namely, lobes 83, 84, is designed to limit the amount of spring winding and unwinding so that the when the force from the damping mechanism and arm are combined the resultant force or belt tension between free arm and minimum belt position is approximately equal. After the minimum belt condition the damping cam geometry is also designed to minimize the belt tension to make installing the belt simpler by limiting the amount of load required to move the tensioner to the load condition (FIG. 8). FIG. 13 shows the belt tension curve relative to arm position.

To minimize the load on the internal components of the tensioner the damping band 50 is positioned to locate the reaction force on the pivot pin 13 within a mounting surface on the engine. Minimizing the load on the internal components aids in packaging all the components within the perimeter of pulley 70.

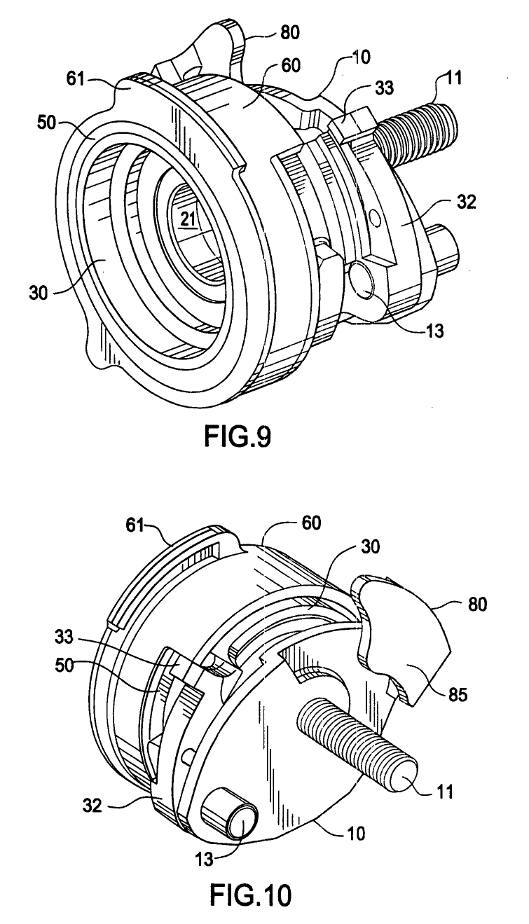

FIG. 9 is a top perspective view of the tensioner. Spring 40 and pulley 70 are omitted from this view. Damping cam 80 is fixedly connected to damping mechanism 60. Damping mechanism 60 is pivotally engaged with arm 30 through damping member 50. Arm 30 pivots about pivot pin 13. Pivot pin 13 engages a mounting surface, such as an engine. Mounting the tensioner at two points, namely, 13 and 11, prevents unwanted rotation of the tensioner once it is installed.

FIG. 10 is a bottom perspective view of the tensioner. Spring 40 and pulley 70 are omitted from this view. Pivot pin 13 and fastener 11 extend from base 10. Fastener 11 is a bolt. Member 61 receives end 42 of spring 40. Portion 85 of damping cam 80 extends under base 10 as a means of support.

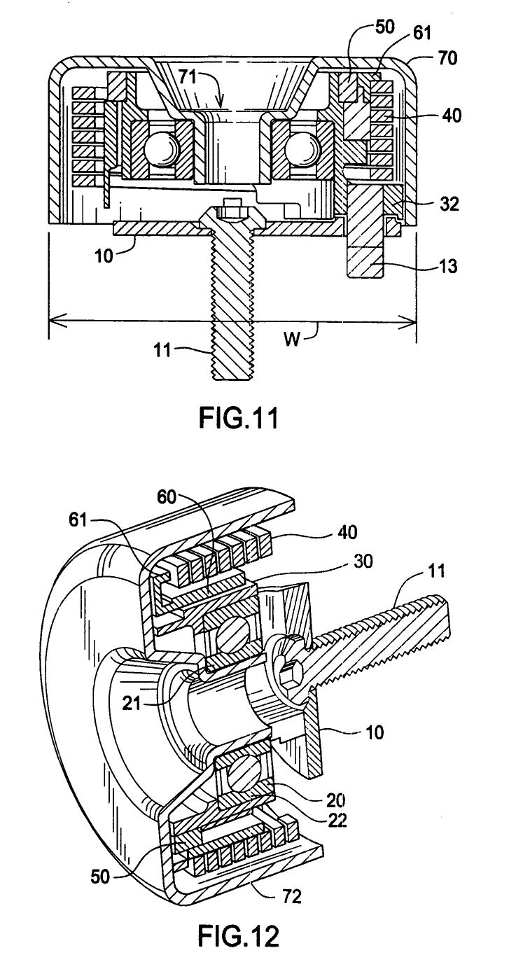

FIG. 11 is a cross-sectional view of the tensioner. The components of the tensioner are fully contained within a perimeter W of the pulley 70. Installation of the tensioner is accomplished by engaging a tool to fastener 11 though hole 71 in the center of pulley 70.

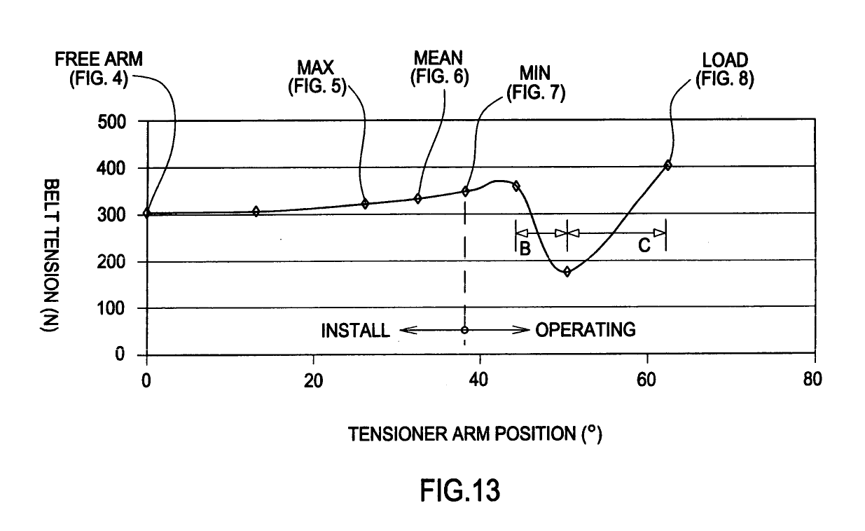

FIG. 12 is a perspective cross-sectional view of the tensioner. Belt engaging surface 72 is flat, but may have any suitable profile known in the art, for example, multi-ribbed.

FIG. 13 is a chart showing belt tension as a function of arm position. The “free arm” or 0° tensioner arm position is the unloaded position. The belt tension is given in Newtons (N).

Each tensioner position is identified with respect to the corresponding Figure. The operating conditions are generally shown in FIG. 8. The installation and removal conditions are shown in FIGS. 4, 5, 6, 7.

The change in belt tension as the arm moves through region “B” is caused by the change of contact from lobe 84 to lobe 83 as described in FIG. 8. Further operational increases in belt load are represented in region “C”.

Although a form of the invention has been described herein, it will be obvious to those skilled in the art that variations may be made in the construction and relation of parts without departing from the spirit and scope of the invention described herein.

I claim:

1. A tensioner comprising:
a base;
a pivot arm pivotally engaged with the base;
a pulley journalled to the pivot arm, the pulley mounted to the inner race of a bearing, the outer race mounted to the pivot arm;
a spring engaged between the pivot arm and a damping mechanism, the damping mechanism frictionally engaged with the pivot arm;
the damping mechanism slidingly engaged with the base between at least two predetermined mechanically fixable positions; and
the pivot arm, spring and damping mechanism contained within a pulley perimeter.

2. The tensioner as in claim 1, wherein the damping mechanism comprises a first lobe for engaging the base.

3. The tensioner as in claim 1, wherein the spring comprises a torsion spring.

4. The tensioner as in claim 1, wherein the base comprises a substantially linear member for engaging the damping mechanism.

5. The tensioner as in claim 1, wherein the damping mechanism comprises at least two lobes, each lobe engagable with the base.
